(19) United States
(12) Patent Application Publication
(10) Pub. No.: US 2010/0101196 A1
(43) Pub. Date: Apr. 29, 2010

(54) GAS FILTRATION STRUCTURE WITH UNDULATED WALL

(75) Inventors: Francisco Jose Carranza, Brussels (BE); Alessandro Giassi, Paris (FR); Francois Vianey, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain CTR DE Rech. ET D'Etudes Europeen, Courbevoie (FR)

(21) Appl. No.: 12/525,674

(22) PCT Filed: Jan. 31, 2008
(86) PCT No.: PCT/FR08/50155

§ 371 Date: Sep. 2, 2009

(30) Foreign Application Priority Data
Feb. 5, 2007 (FR) 0753062

(51) Int. Cl. B01D 46/00; B01D 39/14

(52) U.S. Cl. 55/350.1; 55/522; 55/419

(57) ABSTRACT

The invention relates to a structure for filtering particle-laden gases, of the honeycomb type and comprising an assembly of longitudinal adjacent channels of mutually parallel axes, separated by porous walls, said structure being characterized in that at least one, and preferably all, of the walls joining two vertices of a channel and separating the latter from a contiguous channel has, in cross section and with respect to the center of said channel, at least one concavity and at least one convexity.

The invention relates to the field of filtering structures, which may comprise a catalytic component, for example those used in an exhaust line of an internal combustion engine of the diesel type.

Filters for the treatment of gases and for eliminating soot particles typically coming from a diesel engine are well known in the prior art. These structures usually all have a honeycomb structure, one of the faces of the structure allowing entry of the exhaust gases to be treated and the other face for exit of the treated exhaust gases. The structure comprises, between the entry and exit faces, an assembly of adjacent ducts or channels of mutually parallel axes, separated by porous walls. The ducts are closed off at one or other of their ends so as to form inlet chambers opening onto the entry face and outlet chambers opening onto the exit face. The channels are alternately closed off in an order such that, in the course of their passage through the honeycomb body, the exhaust gases are forced to pass through the sidewalls of the inlet channels in order to rejoin the outlet channels. In this way, the particulates or soot particles are deposited and accumulate on the porous walls of the filter body.

Currently, for gas filtration, filters made from porous ceramic material, for example made from cordierite, from alumina, from mullite, from silicon nitride, from a silicon/silicon carbide mixture or from silicon carbide are used.

In a known manner, during use, the particulate filter is subjected to a succession of filtration (soot accumulation) and regeneration (soot elimination) phases. During the filtration phases, the soot particles emitted by the engine are retained and deposited inside the filter. During the regeneration phases, the soot particles are burnt off inside the filter, in order to restore its filtering properties to it. During these regeneration phases, the filter is subjected to intensive thermomechanical stresses liable to cause, over the duration, microcracks likely to impair the efficiency of filtration and in the end require the filter in an exhaust line to be changed. To reduce such risks, a material may be chosen that exhibits very good thermomechanical resistance, such as silicon carbide. Likewise, by reducing the frequency of the regeneration phases it should be possible to further increase the lifetime of the filters.

It is furthermore known that the introduction of a particulate filter as described above into the exhaust line of an engine leads to a pressure drop, that is to say a pressure differential between the incoming gases and the outgoing gases, which is liable to impair the performance of the engine. Consequently, the filter must be configured in such a way as to avoid such an impairment, by minimizing said pressure drop, whether it is in a state not laden with soot, for example a new filter or after a regeneration phase, or in a state in which it is laden with soot. It is particularly important, in an application as a particulate filter, to minimize the pressure drop in operation so as not to downgrade the power of the engine and not to appreciably increase the fuel consumption, whether or not the filter is laden with soot or residues.

In addition to the soot treatment problem, the conversion of polluting emissions in the gas phase (i.e. mainly carbon monoxide (CO) and unburnt hydrocarbons (HC) or even nitrogen oxides (NOₓ)) into less harmful gases requires an additional catalytic treatment. Thus, most advanced current filters also have a catalytic additional component. Depending on the processes conventionally used, the catalytic function is obtained by impregnating the honeycomb structure with a solution comprising the catalyst, or a precursor of the catalyst, generally based on a precious metal of the platinum group.

Another critical criterion for the selection of the filtering structures is their soot deposition time. This time corresponds to the time period required for the filter to reach its maximum filtering efficiency level, when it is first implemented or following a regeneration phase. It is assumed that this time depends, in particular, on the deposition of a sufficient quantity of soot within the porosity of the filter in order to impede the direct passage of fine soot particles through the walls of the filter. One of the direct consequences of an inappropriate soot deposition time is the appearance of persistent and noxious black fumes, together with the presence of traces of soot at the outlet of the exhaust line, on a new filter or after a regeneration phase. It goes without saying that, for reasons of environmental impact, of image and of comfort of use, automobile manufacturers would like the occurrence of such phenomena to be eliminated, or at least minimized, on vehicles fitted with such filters.

The deposition of soot is a poorly understood phenomenon, owing without doubt to the fact that the mass of deposit is not measurable in real time on a filter during use. Indeed, only the soot deposition time measured indirectly based on the analysis of the concentration of particulates present in the exhaust gases at the outlet of the filter is accessible. The homogeneity of the soot deposit may vary, that is to say the thickness of this deposit may vary to a greater or lesser extent along the length direction of the filter or the distribution of the deposit may vary over the cross section of the entry channels. A deposit as homogeneous as possible within the structure therefore makes it possible to minimize the soot deposition time and therefore the emission of black fumes.

For example, one solution for reducing the soot deposition time consists in reducing the porosity, that is to say typically the pore volume and/or the diameter of the pores of the material constituting the filtering walls of the filter, but this results in an undesirable increase in the pressure drop across the filter.

In most honeycomb filters currently sold, the inlet and outlet channels have a square cross section. Such symmetrical structures have the advantage of exhibiting relatively short soot deposition times, but also have certain drawbacks such as a low filtration area and a high pressure drop when the filter is laden with soot. Furthermore, these symmetrical structures are characterized by a low volume for storing residues. The term “residues” is understood, within the context of the present description, to mean the residual fraction of particles that cannot be burnt off during regeneration of the filter.

The publication WO 2005/016491 discloses a filtering block characterized by walls having a periodic undulation such that the structure is asymmetric. In such structures, the overall volume of inlet channels is greater than that of the outlet channels. Such a configuration makes it possible, for the same pressure drop, to increase the filtration area and the maximum residue storage volume. This increase helps to reduce the regeneration frequency and thus increase the lifetime of the filter. However, trials carried out by the Applicant have shown that such a configuration results a contrario in an appreciable increase in the soot deposition time.

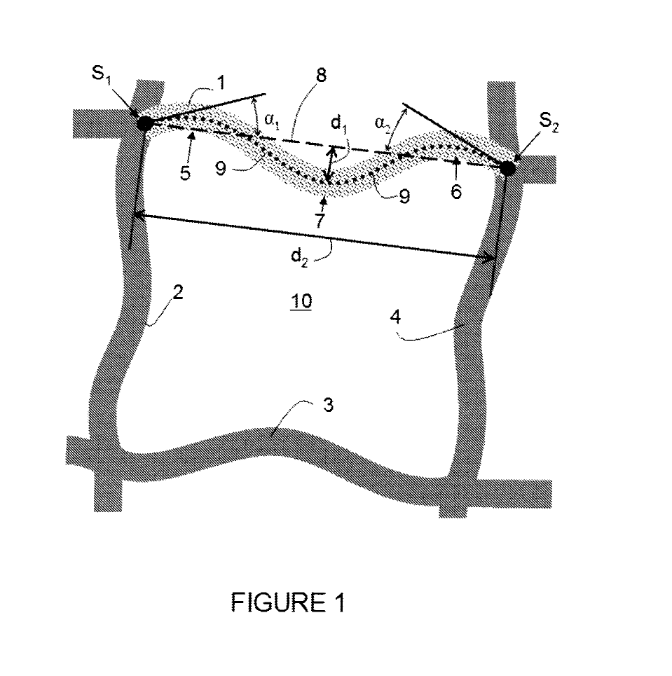

EP 1 125 704 B1 discloses a filter with channels bounded by portions of walls, some of which are concave and others are straight and/or convex, as shown in FIGS. 1, 3 and 4 of that patent. According to this teaching, such a configuration makes it possible, at a constant volume, to increase the overall area of said walls, relative to a section of cells of the square type, and to increase the interactions between the gas and the walls. However, the residue storage volume of these structures is not improved over that of channels with a square cross section. Nor is the soot deposition time of these structures improved over that of channels with a square cross section.

In patent application EP 1 495 791, another solution provides a filter of asymmetric structure, that is to say one in which the volume occupied by the gas inlet channels is greater than the volume occupied by the gas outlet channels. The inlet channels have a cross section typically of octagonal form and the outlet channels have a square cross section. According to that teaching, such a configuration makes it possible for the residue storage volume to be appreciably improved, while still maintaining an acceptable level of pressure drop when the filter is laden with soot. However, owing to the reduced volume of the outlet channels, the high value of the pressure drop inherent in the filter, that is to say in the absence of soot or particles, makes such a filter more difficult to use in an exhaust line.

The object of the present invention is to provide a filtering structure having the best compromise between:
a low pressure drop brought about when a filtering structure is in operation, that is to say typically when it is in an exhaust line of an internal combustion engine, both when it is free of soot particles and when it is laden with particles;
a high residue storage volume so as to reduce the regeneration frequency; and
an optimum filtration efficiency right from the start of operation of the filter, that is to say a minimized soot deposition time, owing to the fact that soot is deposited as uniformly as possible within the inlet channels along their length direction and/or over their cross section.

In its most general form, the present invention relates to a structure for filtering particle-laden gases, of the honeycomb type and comprising an assembly of longitudinal adjacent channels of mutually parallel axes, separated by porous walls, said structure being characterized in that at least one, and preferably all, of the walls joining two vertices of a channel and separating the latter from a contiguous channel has, in cross section and with respect to the center of said channel, at least one concavity and at least one convexity.

For example, said wall or walls have at least two changes of curvature.

According to one possible embodiment, said wall or walls have at least two points of inflection.

Preferably, the number of points of inflection is, according to the invention, between 2 and 4 inclusive, or between 2 and 3 inclusive and very preferably is equal to 2.

According to the invention, the distance d₂ between the two consecutive vertices of said channel may be between about 0.1 mm and about 10 mm, preferably between about 0.2 mm and about 5 mm and very preferably between about 0.5 mm and about 3 mm.

In a filtering structure according to the invention, the number of walls defining a channel may be equal to 3, 4, 6 or 8 and preferably may be equal to 4 or 6.

In one embodiment of a filtering structure according to the invention, which includes at least one channel bounded by three walls, in a cross section, the angle α defined between the straight line joining two consecutive vertices and the tangent to the wall at one of said vertices is advantageously between about 13° and about 30°.

In another embodiment of a filtering structure according to the invention, which includes at least one channel bounded by four walls, in a cross section, the angle α defined between the straight line segment joining two consecutive vertices of said channel and the tangent to the central core of the wall at one of said vertices is advantageously between about 20° and about 45°.

In another embodiment of a filtering structure according to the invention, which includes at least one channel bounded by six walls, in a cross section, the angle α defined between the straight line segment joining two consecutive vertices of said channel and the tangent to the central core of the wall at one of said vertices is advantageously between about 25° and about 60°.

Advantageously, in a filtering structure according to the invention, in a cross section, the ratio of the maximum distance d₁ separating the central core of said wall from the straight line segment joining said consecutive vertices of a channel to the distance d₂ separating these two vertices is between 0.01 and 0.3, preferably between 0.02 and 0.1.

In general, the channel or channels having at least one concavity and at least one convexity have at least one longitudinal plane of symmetry and preferably at least two longitudinal planes of symmetry.

According to one possible embodiment, the structure according to the invention further includes a catalytic coating for the treatment of polluting gases of the CO or HC or NOₓ type.

According to the invention, the walls of the filtering structure have approximately constant thicknesses. Advantageously, in the present structure, the thickness of the walls is between 200 and 500 μm. The density of channels per cm² is between 1 and 280, preferably between 15 and 65.

The filtering structure according to the invention may be made from cordierite, from alumina, from mullite, from silicon nitride, from a silicon/silicon carbide mixture, from alumina titanate or preferably from silicon carbide.

The invention also relates to a filtering element comprising a structure as described above, in which the channels are closed off at one or other of their ends so as to form inlet chambers opening onto the entry face and outlet chambers opening onto the exit face. Said structure comprises for example a plurality of honeycomb filtering elements joined together by a sealing cement.

Finally, the invention relates to the use of the structure as a particulate filter, whether catalyzed or not, in an exhaust line of a diesel or gasoline engine, preferably a diesel engine.

FIGS. 1, 2 and 3 illustrate a nonlimiting exemplary embodiment of a structure, for example a filtering structure, having channels according to the invention.

FIG. 1 is a cross-sectional view of an inlet channel having four walls, in which the characteristic elements of a wall according to the invention have been shown.

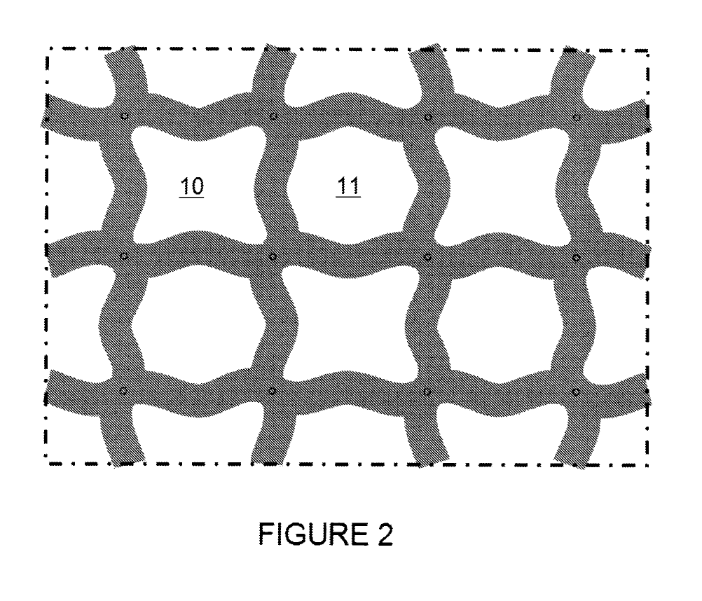

FIG. 2 is an overall cross-sectional view illustrating the arrangement of several channels within a structure according to the invention.

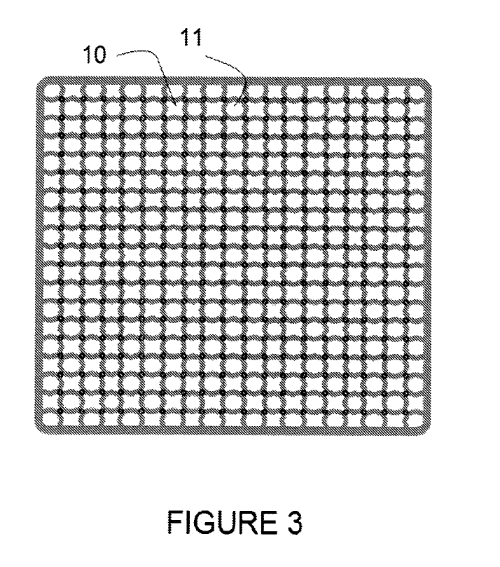

FIG. 3 shows a front view of a monolithic element comprising inlet and outlet channels according to the invention.

FIG. 1 shows a gas inlet channel 10 consisting of four walls referenced 1 to 4 having a profile according to the invention, that is to say two concavities 5 and 6 and a convexity 7 relative to an observer placed at the center of said cavity.

Each wall, for example the wall 1 extending between the vertices S₁ and S₂, is characterized by:
the angles α₁ and α₂ defined, on the one hand, by the straight line segment 8 joining the two consecutive vertices S₁ and S₂ of the channel and, on the other hand, by the tangent to the central core 9 of the wall at the vertex S₁ in the case of α₁ and S₂ in the case of α₂;
a distance d₂ between the two consecutive vertices S₁ and S₂ of the channel 10; and
a distance d₁ defined as the maximum distance separating the central core 9 of said wall from the straight line segment 8 joining the vertices S₁ and S₂.

FIG. 1 illustrates one particular embodiment according to the invention in which the wall has one concavity and two convexities with respect to the center of the reference channel.

FIG. 2 shows the arrangement of a set of gas inlet channels 10 and gas outlet channels 11 in a cross section of a honeycomb structure according to the invention.

FIG. 3 shows schematically the arrangement of the channels 10 and 11 in a monolithic filter block according to the invention.

The invention and its advantages will be more clearly understood on reading the following nonlimiting examples.

### EXAMPLE 1

A first population of honeycomb monolithic elements or monoliths made of silicon carbide was synthesized according to the techniques of the prior art, for example that described in the patents EP 816 065, EP 1 142 619, EP 1 455 923 or WO 2004/090294.

To do this, the following were mixed in a mixer:
3000 g of a mixture of silicon carbide particles with a purity greater than 98% and having a particle size such that 70% by weight of the particles had a diameter greater than 10 microns, the median diameter of this particle size fraction being less than 300 microns. Within the context of the present description, the median diameter denotes the particle diameter below which 50% by weight of the population lies; and
150 g of an organic binder of the cellulose type.

Water was added and mixing continued until a homogeneous paste was obtained that had the plasticity allowing it to be extruded, the die being configured so as to obtain monolith blocks, the channels and external walls of which had a square structure.

The green monoliths obtained were dried by microwave for a time sufficient to bring the proportion of water not chemically bound to less than 1% by weight. The channels of each face of the monolith were alternately closed off according to well-known techniques, for example those described in application WO 2004/065088.

The monoliths were then fired up to a temperature of 2200° C., which temperature was maintained for 5 hours. The porous material obtained, comprising very predominantly recrystallized α-SiC, had an open porosity of 47% and an average pore distribution diameter of around 15 μm. The dimensional characteristics of the elements thus obtained are given in Table 1 below.

A filter was then assembled from the monoliths. Sixteen elements coming from the same mixture were assembled together using the conventional technique of bonding by means of a cement having the following chemical composition: 72 wt % SiC, 15 wt % Al₂O₃, 11 wt % SiO₂, the balance consisting of impurities, predominantly of Fe₂O₃ and oxides of alkali and alkaline-earth metals. The average thickness of the join between two neighboring blocks was around 2 mm. The assembly was then machined, so as to constitute assembled filters of cylindrical shape with a diameter of 14.4 cm.

### EXAMPLE 2

The technique of synthesizing the monoliths described above was again repeated in the same way, except that this time the die was adapted so as to produce monolith blocks characterized by a wavy arrangement of the internal channels. Monoliths in accordance with those described in relation to FIG. 3 of application WO 05/016491 were obtained. In a cross section, the undulation of the walls was characterized by a degree of asymmetry, as defined in WO 05/016491, of 7%.

### EXAMPLE 3

The technique of synthesizing the monoliths described above was again repeated in the same way, except that this time the die was adapted so as to produce monolith blocks characterized by an octagonal arrangement of the internal inlet channels as illustrated by FIG. 6b of application EP 1 495 791.

### EXAMPLE 4

The technique of synthesizing the monoliths described above was again repeated in the same way, except that this time the die was adapted so as to produce monolith blocks characterized by an arrangement of channels identical to those of FIG. 1a of application EP 1 125 704, with a degree of asymmetry of 7%, as defined above.

### EXAMPLE 5

### According to the Invention

The technique of synthesizing the monoliths described above was again repeated in the same way, except that this time the die was adapted so as to produce monolith blocks characterized by an arrangement of internal inlet channels according to the invention, that is to say according to FIG. 1 described above. The arrangement of the channels was characterized by the following values:
α₁=37°;
α₂=37°;
d₁=0.1 mm;
d₂=1.8 mm,
   i.e. a d₁/d₂ value equal to 0.055.

The main structural characteristics of the elements obtained according to Examples 1 to 5 are given in Table 1. The technique of assembling and obtaining the filters was the same for all the examples and as described in Example 1.

The dies were configured in such a way that the monoliths obtained according to the above Examples 1 to 5 had the same density of cells per unit area in cross section. In the examples, the density of channels was 180 cpsi (“cells per square inch”), i.e. 27.9 channels per cm², 1 cpsi being equal to 1 cell/6.45 cm².

TABLE 1

| | Example | | | | |
|---|---|---|---|---|---|
| | 1 | 2 | 3 | 4 | 5 |
| Model | EP816065 | WO05/16491 | EP1495791 | EP1125704 | According to |
| | | | | | the invention |
| Inlet channel | square | wavy | octagonal | undulating | concave/convex |
| geometry | | | | | |
| Monolith | 36 | 36 | 36 | 36 | 36 |
| element size | | | | | |
| (mm) | | | | | |
| Channel | 27.9 | 27.9 | 27.9 | 27.9 | 27.9 |
| density | | | | | |
| (channels/cm²) | | | | | |
| Element | 20.32 | 20.32 | 20.32 | 20.32 | 20.32 |
| length (cm) | | | | | |
| Thickness e | 300 | 300 | 300 | 300 | 300 |
| of the | | | | | |
| internal | | | | | |
| walls (μm) | | | | | |
| Equivalent | 1.6 | 1.9 | 2.0 | 1.5 | 1.7 |
| hydraulic | | | | | |
| diameter* (mm) | | | | | |

*the hydraulic diameter of the inlet channels is equal to 4 A/P where A is the area of the cross section of the inlet channels and P is their perimeter.

The specimens obtained were evaluated and characterized according to the following operating methods:

A—Measurement of the Pressure Drop in the Laden or Unladen State:

The term “pressure drop” is understood within the context of the present invention to mean the differential pressure existing between the upstream side and the downstream side of the filter. The pressure drop was measured according to the techniques of the prior art for a gas flow of 600 Sm³/h and a temperature of 300° C., firstly on fresh filters.

For the pressure drop measurement on a laden filter, the various filters were mounted beforehand on an exhaust line of a 2.0 l diesel engine running at full power (4000 rpm) for 30 minutes and then dismantled and weighed in order to determine their initial weight. The filters were then remounted on the engine test bench with a speed of 3000 rpm and a torque of 50 Nm so as to obtain soot loads in the filter of 8 g/l. The pressure drop measurement on the filter thus laden with soot was carried out as on the fresh filter.

B—Measurement of the Soot Deposition Time:

To do this, the filter to be tested was placed on an exhaust line of an engine on the engine test bench. The engine used was of the diesel type with a capacity of 2.0 liters. The filter was progressively loaded with soot by the operation of the engine at a speed of 3000 rpm at 50 Nm. The test bench was equipped with an ELPI (Electrical Low Pressure Impactor) system which allowed the particulate concentration in a gas to be continuously measured in real time starting from the moment the filter was loaded. A curve of filtration efficiency as a function of time was thus obtained, this being characterized by a quasi-plateau after a given testing time. The plateau corresponds to a filtration efficiency greater than or equal to 99%. The period of time between the start of the loading of the filter and the time from which an efficiency equal to at least 99% is obtained corresponds, according to the present invention, to the soot deposition time.

The results obtained in the tests for the set of Examples 1 to 5 are given in Table 2 below:

TABLE 2

| | Example | | | | |
|---|---|---|---|---|---|
| | 1 | 2 | 3 | 4 | 5 |
| OFA (%)* | 34 | 44 | 48 | 34 | 41 |
| Filtration | 2180 | 2296 | 2412 | 2222 | 2351 |
| area (cm²) | | | | | |
| Residue | 89.3 | 115.0 | 126.3 | 89.3 | 107.5 |
| storage | | | | | |
| volume | | | | | |
| (cm³) | | | | | |
| Pressure | 3920 | 4430 | 5080 | 3895 | 4080 |
| drop ΔP₀ | | | | | |
| (Pa) in the | | | | | |
| fresh or | | | | | |
| soot-unladen | | | | | |
| state | | | | | |
| Pressure | 31 400 | 29 200 | 29 840 | 30 000 | 28 450 |
| drop ΔP_{8 gr/l} | | | | | |
| (Pa) in the | | | | | |
| soot-laden | | | | | |
| state | | | | | |
| Soot | 300 | 360 | 375 | 305 | 325 |
| deposition | | | | | |
| time (s) | | | | | |

*OFA (open frontal area) is the ratio of the area covered by the sum of the cross sections of the inlet channels on the front face of a monolith to the cross-sectional area of said monolith.

### Analysis of the Results:

Comparison of the data given in Table 1 shows that the filter according to the invention (Example 5) has the best compromise between the various properties sought, especially the lowest pressure drop in the laden state, a filtration area among the highest, while still maintaining a soot deposition time among the lowest, together with a pressure drop on the fresh filter and a soot storage volume that are very satisfactory for the application.

Furthermore, the structures according to the invention are characterized by a better compromise between the pressure drop caused by the filter, whether or not it is laden with soot, and the soot deposition time. The structures according to the invention are thus particularly advantageous in the case in which they incorporate an additional catalytic component. More particularly, owing to this better compromise, it is possible according to the invention to synthesize highly porous structures in which the loading of catalyst (and consequently the efficiency of the catalytic treatment) is appreciably increased, without thereby giving the soot deposition time of the catalytic filter thus obtained a value deemed to be unacceptable.

1. A structure for filtering particle-laden gas in the form of a honeycomb and comprising
an assembly of longitudinal adjacent channels (10) of mutually parallel axes, separated by porous walls, and
at least one wall joining two vertices of a channel and separating the latter from a contiguous channel which has, in cross section and with respect to the center of said channel, at least one concavity and at least one convexity, said wall or having at least two points of inflection.

2. The filtering structure as claimed in claim 1, in which said at least one wall has at least two changes of curvature.

3. The filtering structure as claimed in claim 1, in which said at least one wall has a number of points of inflection between 2 and 4.

4. The filtering structure as claimed in claim 1, in which the distance between the two vertices is between about 0.1 mm and about 10 mm.

5. The filtering structure as claimed in claim 1, in which the number of walls defining a channel is equal to 3, 4, 6 or 8.

6. The filtering structure as claimed in claim 1, which comprises at least one channel bounded by three walls and in which, in a cross section, the angle α defined by the straight line joining two consecutive vertices and by the tangent to the wall at one of said vertices is between about 13° and about 30°.

7. The filtering structure as claimed in claim 1, which comprises at least one channel bounded by four walls and in which, in a cross section, the angle α defined by the straight line segment joining two consecutive vertices of said channel and by the tangent to the central core of the wall at one of said vertices is between about 20° and about 45°.

8. The filtering structure as claimed in claim 1, which comprises at least one channel bounded by six walls and in which, in a cross section, the angle α defined by the straight line segment joining two consecutive vertices of said channel and by the tangent to the central core of the wall at one of said vertices is between about 25° and about 60°.

9. The filtering structure as claimed in claim 1, in which, in a cross section, the ratio of the maximum distance d₁ separating the central core of said wall from the straight line segment joining said consecutive vertices of a channel to the distance d₂ separating these two vertices is between 0.01 and 0.3.

10. The filtering structure as claimed in claim 1, in which the channel or channels have at least one longitudinal plane of symmetry.

11. The structure as claimed in claim 1, which further comprises a catalytic coating for the treatment of polluting gases selected from the group consisting of CO and NOₓ type.

12. The structure as claimed in claim 1, in which the thickness of the walls is between 200 and 500 μm.

13. The structure as claimed in claim 1, in which the density of channels per cm² is between 1 and 280.

14. A filtering element comprising a structure as claimed in claim 1, in which the channels are closed off at one or other of their ends so as to form inlet chambers opening onto the entry face and outlet chambers opening onto the exit face.

15. A filtering structure comprising a plurality of honeycomb filtering elements as claimed in claim 14, joined together by a sealing cement.

16. An exhaust line of a diesel or gasoline engine, comprising the filtering structure as claimed in claim 1.

17. The filtering structure as claimed in claim 1, in which the distance between the two vertices is between about 0.2 mm and about 5 mm.

18. The filtering structure as claimed in claim 1, in which the distance between the two vertices is between about 0.5 mm and about 3 mm.

19. The filtering structure as claimed in claim 1, in which the number of walls defining a channel is equal to 4 or 6.

20. The filtering structure as claimed in claim 1, in which, in a cross section, the ratio of the maximum distance d₁ separating the central core of said wall from the straight line segment joining said consecutive vertices of a channel to the distance d₂ separating these two vertices is between 0.02 and 0.1.

21. The filtering structure as claimed in claim 1, in which the channel or channels have at least two longitudinal planes of symmetry.

22. The structure as claimed in claim 1, in which the density of channels per cm² is between 15 and 65.
